(19) United States
(12) Patent Application Publication
(10) Pub. No.: US 2006/0112197 A1
(43) Pub. Date: May 25, 2006

(54) Dual-interface-plug memory card

(76) Inventor: Li-Ho Yao, Taipei (TW)

Correspondence Address: Jackson Walker L.L.P., Suite 2100, 112 E. Pecan Street, San Antonio, TX, 78205, US

(21) Appl. No.: 10/997,702

(22) Filed: Nov. 24, 2004

(51) Int. Cl. G06F 3/00

(52) U.S. Cl. 710/15

(57) ABSTRACT

A dual-interface-plug memory card includes an SD, CF or MS memory card. A strobe control unit is applied to control a USB control chip and a memory card control chip. When a USB plug is inserted to a USB hub, the strobe control unit is activated, information can be accessed through the two control chips. On the contrary, if the memory card plug is inserted, the strobe control unit is de-activated and information can only be accessed through the memory card chip. In this way, the two control chips can work independently.

### BACKGROUND OF THE INVENTION

1. Field of the Invention

The present invention relates to a dual-interface-plug memory card, and particularly relates to a dual-interface-plug memory card having a strobe control unit, which can deal with signals from different plugs.

2. Description of Related Art

As the electronic products become popular, the trend of the corresponding memory cards is towards larger capacity and greater compatibility. For example, the standard interfaces of memory card include: CF (compact flash), MS (message store), SD (secure digital) etc. However, a memory card has only a single plug which can not be compatible with the product with a different hub, so a card reader is provided to read memory cards with different interface plugs.

From another aspect, it is possible for the memory card itself to have multiple interface plugs compatible with various products, and such kind of memory card usually has a second interface USB plug besides the original standard plug.

For the memory card integrated with a second interface USB plug, the internal elements mainly include a USB control chip and a memory card control chip. When the two control chips are integrated in a single card, electronic jamming will be a problem for a normal operation.

Therefore, the invention provides a dual-interface-plug memory card having a strobe control unit to mitigate or obviate the aforementioned problems.

### SUMMARY OF THE INVENTION

The main objective of the present invention is to provide a dual-interface-plug memory card having a strobe control unit, which can automatically determine which plug is in operation and deal with different signals from different plugs.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the dual-interface-plug memory card in accordance with this invention;

FIG. 2 is a block circuit diagram of a first embodiment of this invention;

FIG. 3A is a detailed circuit diagram of a USB control chip in accordance with this invention;

FIG. 3B is a detailed circuit diagram of a USB interface and an oscillating circuit in accordance with this invention;

FIG. 3C is a detailed circuit diagram of a USB indicating light in accordance with this invention;

FIG. 3D is a detailed circuit diagram of a memory card control chip in accordance with this invention;

FIG. 3E is a detailed circuit diagram of a memory card interface in accordance with this invention;

FIG. 3F is a detailed circuit diagram of a memory and a strobe control unit in accordance with this invention;

FIG. 4 is a block circuit diagram of a second embodiment in accordance with this invention; and

FIG. 5 is a block circuit diagram of a third embodiment in accordance with this invention.

### DETAILED DESCRIPTION OF THE PREFERRED EMBODIMENT

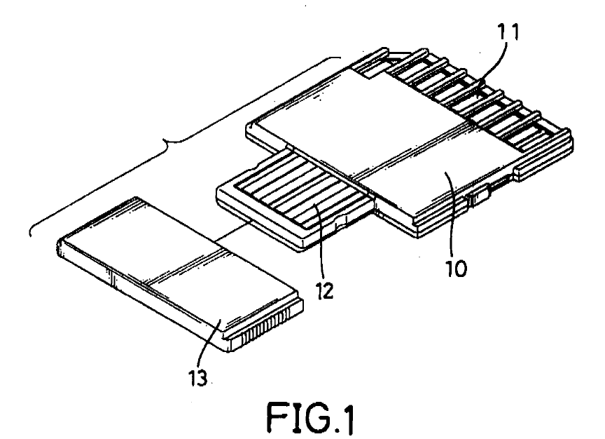

FIG. 1 is a perspective view of a dual-interface-plug memory card in accordance with this invention. A memory card plug (11) (such as CF or SD) and a USB plug (12) are formed in a mainbody (10) of the memory card. The USB plug (12) embedded with conductive point contacts is extended from a first end of the mainbody, and is covered by a cap (13) when not in use. As the cap (13) covers the USB plug, the overall size of the dual-interface-plug memory card conforms to a standard memory card.

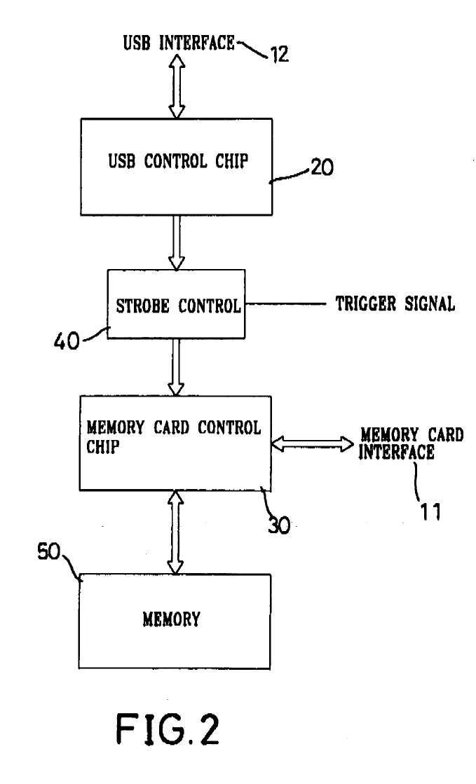

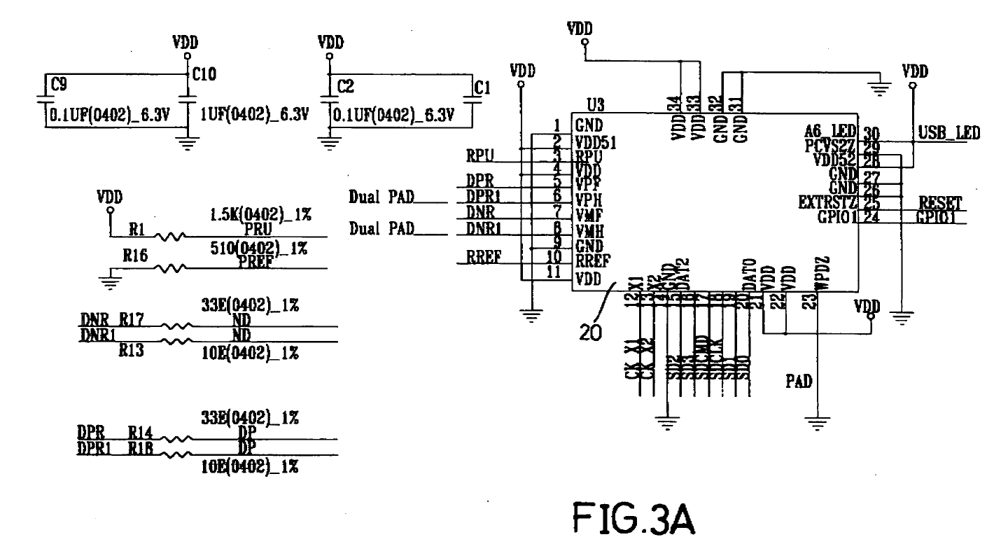

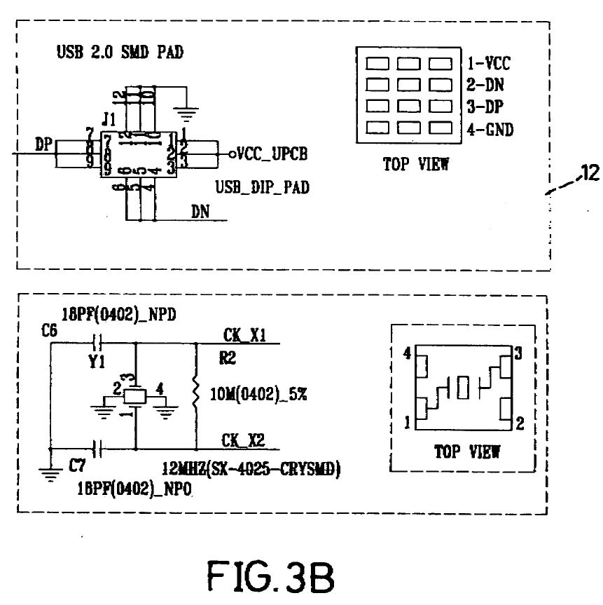

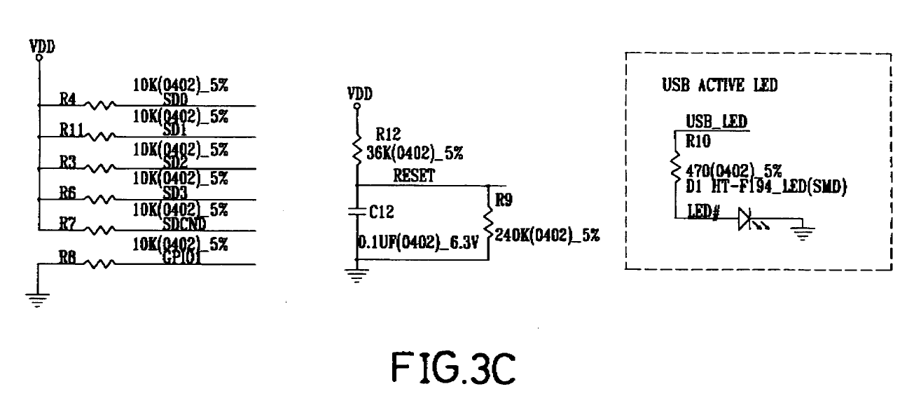

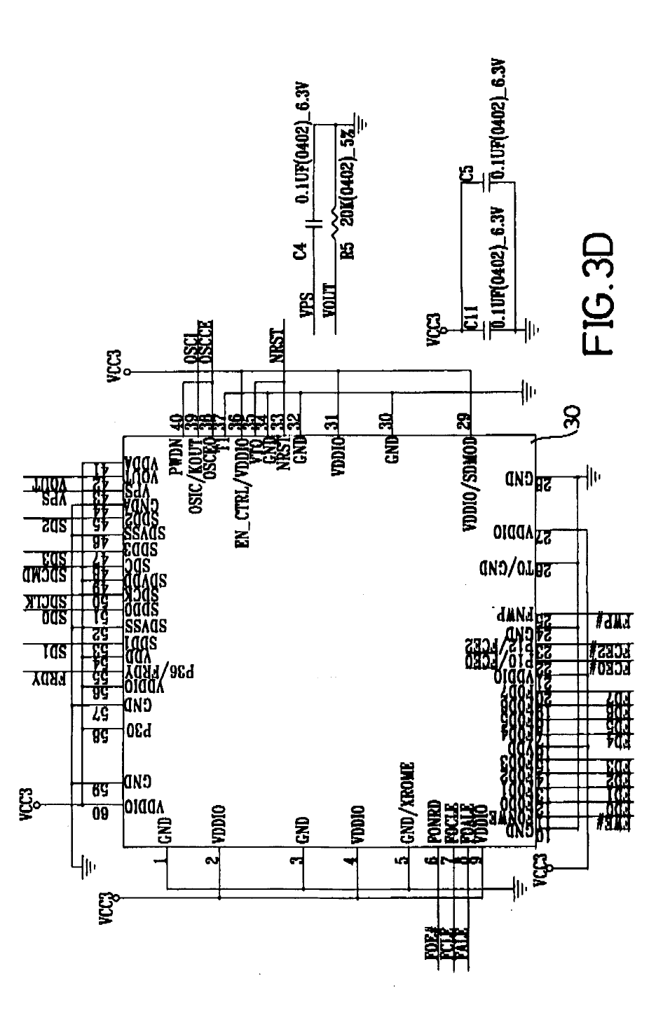

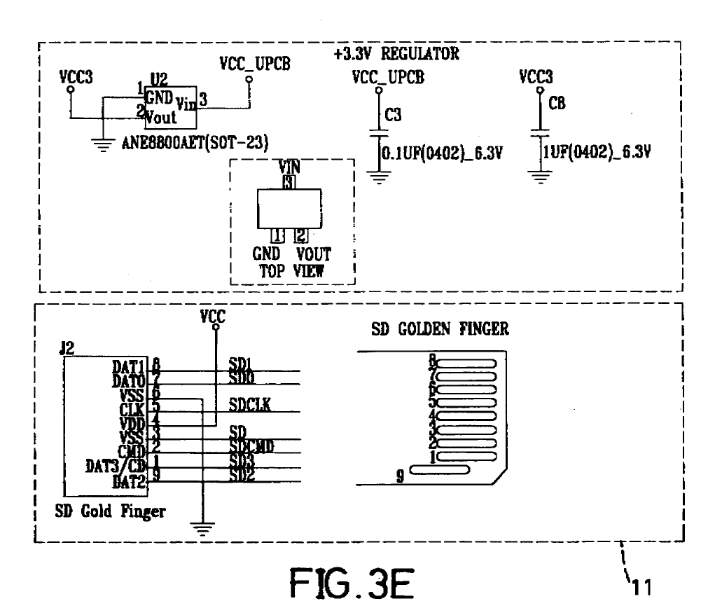

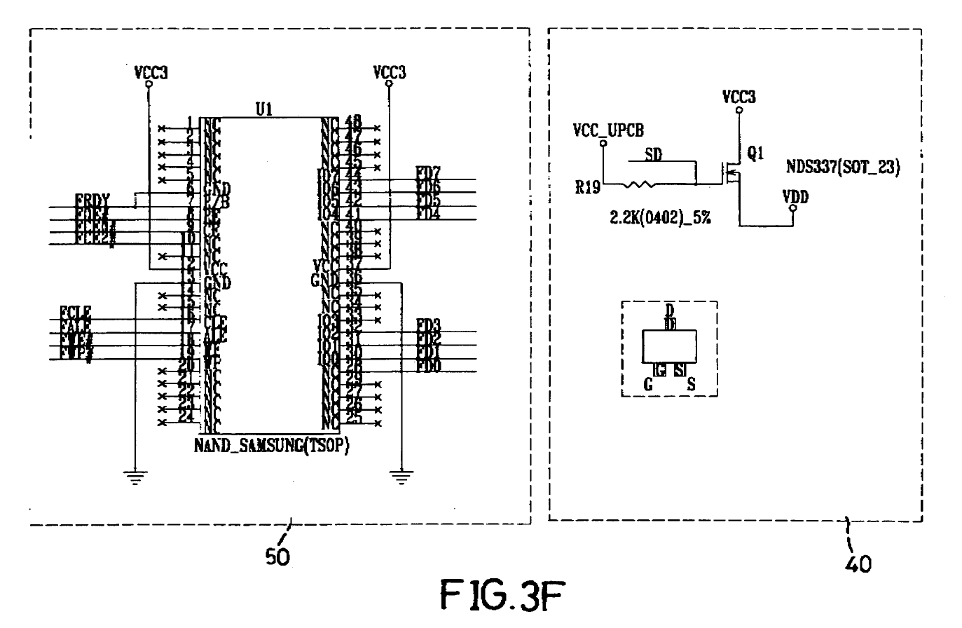

With reference to FIG. 2, the dual-interface plug memory card mainly has a USB control chip (20), a memory card control chip (30) and a strobe control unit (40), wherein the strobe control unit (40) is connected between the USB control chip (20) and the memory card control chip (30). The USB control chip (20) is connected to the USB plug (12) and the memory card control chip (30) is connected to a memory (50) as well as the memory card plug (11). The detailed circuit diagram is shown in FIG. 3 (A)-(F).

When the USB plug (12) is inserted to a USB hub, the strobe control unit (40) is activated, information can be accessed from the memory (50) through the USB control chip (20), the strobe control unit (40), and the memory card control chip (30). On the contrary, if the USB plug (12) is idle, and the memory card plug (11) is inserted to a corresponding external hub, the strobe control unit (40) will be de-activated by a trigger signal, thus the information can only be accessed through the memory card control chip (30), without any disturbance from the USB control chip (20).

With reference to FIG. 3 (F), the strobe control unit (40) consists of a MOSFET (Metal-Oxide-Semiconductor Field Effect Transistor) having a gate as a control pin. Two signals, VCC_UPCB and SD port are connected to the gate. As the USB plug (12) is inserted to the USB hub, the operational power supply VCC_UPCB is obtained, which is further transmitted to activate the strobe control unit (40).

With reference to FIG. 3 (E), taking the SD memory card for example, a pin noted as ‘3’ is a low voltage signal (Vss) port. When the SD plug is inserted to an SD hub, the low voltage signal (Vss) will be transmitted to de-activate the strobe control unit (40), thus the SD control chip (30) is independent of the USB control chip (20).

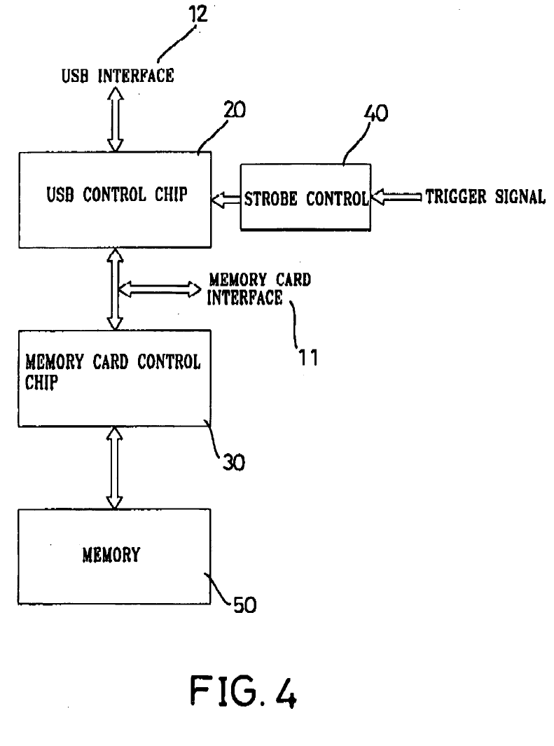

FIG. 4 shows a block circuit diagram of a second embodiment in accordance with this invention. Compared to the first embodiment, the difference is the strobe control unit (40) is attached to the USB control unit (20) instead of the memory card control unit (30). Still, the strobe control unit (40) obtains a trigger signal to determine if the USB plug or memory card plug is in operation. When the memory card plug is inserted, the strobe control unit (40) is de-activated to eliminate the disturbance of the USB control chip (40).

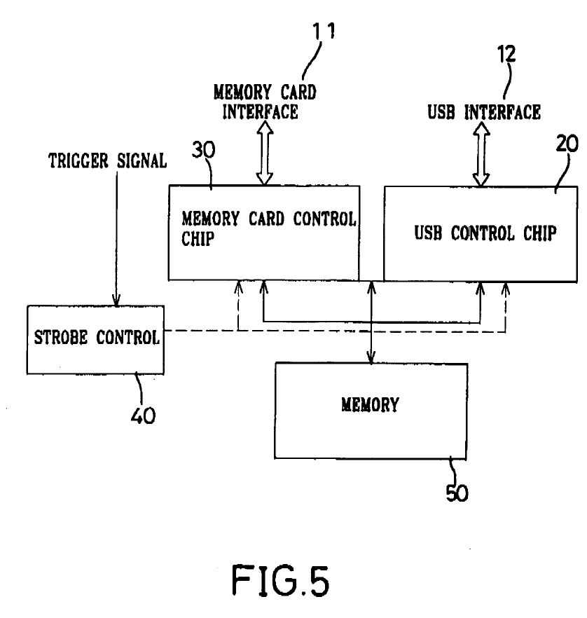

FIG. 5 shows a block circuit diagram of a third embodiment in accordance with this invention. The USB control chip (20) and the memory card control chip (30) are both connected to the memory (50), and the strobe control unit (40) is attached to both of the two chips (20), (30) as well as the USB plug and the (12) and the memory card plug (11), thus the strobe control unit (40) receives the signal from the SD plug or USB plug to determine which is activated to be capable of reading or writing the memory (50).

The memory card referred to in above embodiments can be an SD card or other types of memory card. As long as a trigger signal is transmitted to the strobe control unit (40) to tell which of the plugs is in operation, the strobe control unit (40) is able to determine if itself is activated or de-activated, further effectively enable the selected plug to operate independently, without any disturbance of unnecessary signals.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A dual-interface-plug memory card comprising:
a USB control chip (20) connected to a USB plug (12);
a memory card control chip (30) connected to both a memory (50) and the memory card plug (11); and
a strobe control unit (40) connected to both of the USB control chip (20) and the memory card control chip (30);
wherein when the USB plug (12) is inserted to a USB hub, the strobe control unit (40) is activated and information is accessible from the memory (50), on the contrary, as the memory card plug (11) is inserted to a corresponding hub, the strobe control unit (40) is de-activated, and information is written in or read out from the memory card control chip (30), without any disturbance of the USB control chip (20).

2. The dual-interface-plug memory card as defined in claim 1, wherein the strobe control unit (40) is a MOSFET (Metal-Oxide-Semiconductor Field Effect Transistor) having a gate as a control pin, which receives a voltage signal to determine a status of being activated or de-activated.

3. A dual-interface-plug memory card comprising:
a USB control chip (20) connected to a USB plug (12) and a memory (50);
a memory card control chip (30) connected to a memory card plug (11) and the memory (50), wherein the memory card plug (11) can be inserted to a corresponding hub; and
a strobe control unit (40) connected to both the memory card control chip (30) and the USB control chip (20), wherein a control pin of the strobe control unit (40) is connected to the USB plug (12) and the memory card plug (11);
wherein when the USB plug (12) is inserted to a USB hub, the strobe control unit (40) is activated, information is accessible from the memory (50), on the contrary, as the memory card plug (11) is inserted to a corresponding hub and the USB plug is idle, the strobe control unit (40) is de-activated, and information is written in or read out from the memory card control chip (30), without any disturbance of the USB control chip (20).
